(19) United States
(12) Patent Application Publication
(10) Pub. No.: US 2016/0189203 A1
(43) Pub. Date: Jun. 30, 2016

(54) AUTOMATIC AND DYNAMIC PREDICTIVE ANALYTICS

(71) Applicant: TERADATA US, INC., DAYTON, OH (US)

(72) Inventors: Muhammad Waqas Rajab, Raleigh, NC (US); Eric Anthony Navarro, Raleigh, NC (US); Eleni Anna Rundle, Apex, NC (US); Paul Richard Kristoff, Apex, NC (US); Benjamin J. Ceranowski, Cary, NC (US); Gene Christopher Hovey, Raleigh, NC (US); Jennifer Lyn Baldwin, Apex, NC (US); Tai-Jen Gordon, Dayton, OH (US)

(21) Appl. No.: 14/583,627

(22) Filed: Dec. 27, 2014

(51) Int. Cl. G06Q 30/02

(52) U.S. Cl. CPC G06Q 30/0244

(57) ABSTRACT

An initial communication is created and processed for a set period of time. At the conclusion, customer results associated with positive and negative responses to the communication are fed to an analytic engine to develop a training formula. When the communication is run, the training formula is processed to identify a universe of customers as a segment for use with the communication as scored leads. A campaign is associated with an option to select a most-up-to-date training formula to process to pull up-to-date leads for the campaign each time the campaign is run.

### BACKGROUND

A marketing campaign may have one to many communications that are directed at consumers during the campaign. The campaign as a whole has a target market (customer targeted universe) and each communication within that campaign may have a subset of that market (subset of customers within the customer target universe).

Marketers often want to use the results of previous campaigns when building new campaigns. For example, a marketer can tabulate all the targets and responders from a campaign run last year. To run predictive analytics on this group, the marketer combines the attributes (for example gender, income, zip code, etc.) for the targets and responders and performs analytics like regression.

Predicative analytics is extremely useful in assisting during a campaign or a communication of that campaign by identifying customers that are more likely to respond favorably to the campaign or any communication of the campaign based on using historical results associated with similar campaigns or communications.

However, initially there may be little to no initial historical results from which the predicative analytics can be useful (at least for a new campaign being executed) or the predictive model being used may not be entirely accurate for the campaign, such that the reliability or quality of the predicative analytics at the start of a campaign may be suspect.

As results for executing communications come in for the campaign, the predictive model improves for the predictive analytics. Still, each time a marketer starts a campaign for a communication there is no guarantee that the most-up-to-date model is the model used (as the predictive model may be infrequently updated). As a result, the marketer may have to manually select the most recent predictive model, which the marketer may or may not do.

Also, marketers want to able to decrease the number of customers that need contacted for any communication of a campaign while at the same time increase the likelihood of receiving positive responses from the actual customers that are contacted.

One problem that occurs is that the initial set of leads (universe of customers) for a new communication requires the marketer to: 1) guess at key attributes associated with customers of the proposed universe of customers for the communication (which is prone to error, especially for novice marketers), 2) seek help from an expert (which can be time consuming and costly to the organization as experts are often in short supply and overtaxed), 3) run a software package to assist (which still needs inputs defined and can be as difficult as guessing the key attributes), and 4) any defined universe though a manual process (1 or 2) or semi-automated process (3) needs to be updated each time a communication is performed because attributes associated with customers change over time.

Thus, there is a need for improved automated selection and use of predictive analytics.

### SUMMARY

In various embodiments, automatic and dynamic predictive analytics are presented. According to an embodiment, a method for optimizing customer leads for a communication of a campaign is provided.

Specifically, a communication is obtained and the communication is trained by running the communication to interact with customers. At the conclusion of a training period, positive and negative results from the training period are sent to a predictive analytic engine. Next, a training formula is received as output from the predictive analytic engine and the training formula is linked to the communication.

### BRIEF DESCRIPTION OF THE DRAWINGS

FIG. 1 is diagram depicting components for automatic and dynamic predictive analytics, according to an example embodiment.

FIG. 2 is a diagram of a method optimizing customer leads for a communication of a campaign, according to an example embodiment.

FIG. 3 is a diagram of a method for automated up-to-date predictive analytics for a marketing campaign, according to an example embodiment.

FIG. 4 is a diagram of an automated and dynamic predictive analytic system, according to an example embodiment.

### DETAILED DESCRIPTION

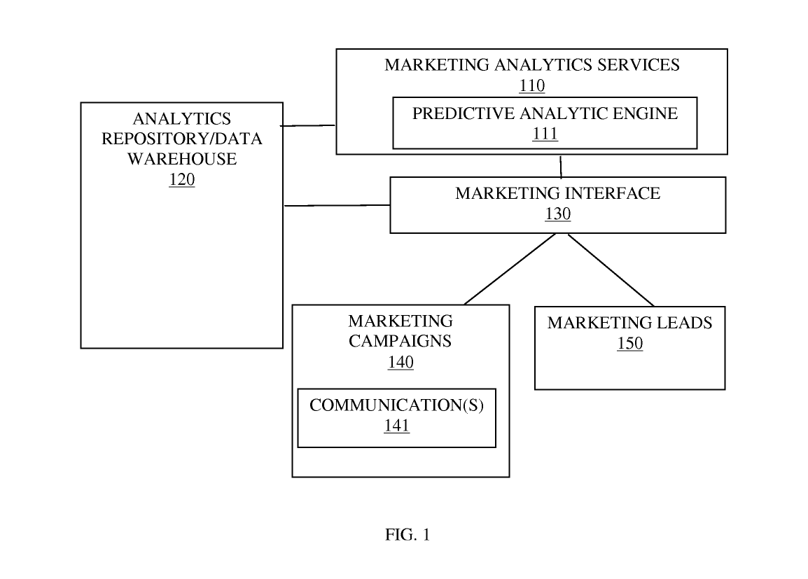

FIG. 1 is diagram depicting components for automatic and dynamic predictive analytics, according to an example embodiment. The diagram depicts a variety of components, some of which are executable instructions implemented as one or more software modules, which are programmed within memory and/or non-transitory computer-readable storage media and executed on one or more processing devices (having memory, storage, network connections, one or more processors, etc.).

The diagram is depicted in greatly simplified form with only those components necessary for understanding embodiments of the invention depicted. It is to be understood that other components may be present without departing from the teachings provided herein.

The diagram includes a marketing analytics services server or servers (marketing analytics services 110), an analytics/data warehouse 120, a marketing interface 130, a variety of instances of marketing campaigns 140, and a variety of instances marketing leads 150 (customer universes for the campaign as a whole or for any given communication 141 of a marketing campaign 140).

The marketing analytics services 110 include a predictive analytic engine 111.

The marketing campaigns 140 include marketing communications 141 (herein after communications 141).

The marketing services 110 include a variety of applications that interacts with the marketing interface 130 (operated by a marketer (analyst)) and that use data defined in the analytics/data warehouse 120 to provide marketing applications and guidance to the analyst or marketer.

The marketing services 110 can include a variety of applications, one of which is a predictive analytics engine 111. The predictive analytic engine 111 uses instances of predictive modules generated by data gathered and clipped by an analyst during a communication 141 with a customer, perhaps during a particular marketing campaign 140. Interactions with customers and data gathered and clipped are provide through the marketing interface 130 and housed in the analytics/data warehouse 120.

The predictive analytic engine 111 can apply the predictive modules against communications or customer segments to generate a scoring (sometimes referred to a as a training). The result of submitting the training to the predictive analytic engine 111 against a communication or a segment (of desired customers) is an analytic schema for selection and clipping, each marketing lead 150 is then clipped or selected based on the score provided by the analyst or marketer.

After an analyst trains a predictive module to create a training, the analyst can use the training to score a segment having potential customer (marketing leads 150) for a desired marketing campaign 140. The segment that the analyst scores is referred to as a scoring segment. When the analyst scores a scoring segment, each customer in the scoring segment indicates how likely the customer will respond to a communication 141. The scores may also be used by the analyst using the marketing interface 130 to build a new segment with the potential best customers (marketing leads 150), or clip an existing segment for a communication.

The predictive analytic engine 111, based on predictive modules, uses a variety of data from the analytics/data warehouse 120 to perform statistical regression and predict how customers are going to respond to given proposed communication or marketing campaign 140 that an analyst wants to do by identifying leads 150 or customer segments for the analyst to pursue.

One issue is that analyst/marketer when starting up a campaign for a day of work, the assigned predictive module may not be the most recent or most up-to-date, since updates may occur infrequently with the predictive analytic engine 111 and the analytics repository/data warehouse 120.

The marketing interface 130 includes an option that the marketer can use to select the latest and most-up-to-date training (predictive module) for a campaign 140. The option instructs the campaign 140 to pull and run the most-recent and up-to-date training through the predictive analytic engine 111 each time the campaign 140 is run by the marketer. So, the campaign 140 automatically pulls the latest training each time it is executed. A marketer will no longer have to manually select the correct training each time the campaign 140 initiates. This ensures that leads 150 generated by the campaign 140 will always be scored and clipped using the latest data (predictive module/training against the analytics repository/data warehouse 120).

However, in some cases, the most-recent training formula can be a very weak formula. Its power value (measurement indicating how good the training is at predicting) and confidence value (measurement indicating how accurate the prediction should be) may be low and it would be best for the marketer to not use the recent training formula in such a case. This is remedied by adding options to the marketing interface 130 that allows for selecting a most-recent training formula that has certain qualities (power and confidence values). Here, the marketer can specify that a training formula used when initiating an instance of the campaign 140 is to have a marketer-defined power and confidence value or relation, such as power greater than 50 and confidence greater than 80. Once the marketer configures the criteria and the most-up-to-date training matches the marketer-defined criteria, the campaign 140 is assigned that training and the campaign runs.

However, if the lasted training formula does not have the required power and confidence criteria, a best available training formula is automatically selected from a pool of available training formulas nearest matching the most-up-to-date training for the campaign 140.

Additionally, the marketing interface 130 provides a mechanism for a marketer to initially define the universe of customer to assign as the leads 150 for a given communication 141. The marketer creates the communication 141, and then sets a time for gathering analytic information for that communication, positive customer responses and negative responses. The positive and negative customer results are provided to the predictive analytic engine 111, which creates a training for the communication 141. The predictive analytic engine identifies (through regression) important attributes associated with those customers that provided positive results to generate the training. The marketer then uses the marketing interface 130 to link the communication 141 to use that training each time the communication 141 is run.

When the communication 141 is run, the training when run through the predictive analytic engine 130 using the analytics repository/data warehouse 120 generates a model universe segment (leads 150), which will limit the customers contacted to what was produced by processing the training.

This reduces the time needed to create a universe segment, since the communication 141 generates the module universe; eliminates guess work; reduces manual errors; reduces the need to wait on experts for assistance; reduces the need to define proper inputs for analytic software, and eliminates the need to regenerate the universe segment (leads 150) each time the communication 141 is run because the options of the marketing interface to always grab the lasts training can be used in the marketing interface 130 as well for the communication 141 (marketer can similarly set power and confidence criteria as well).

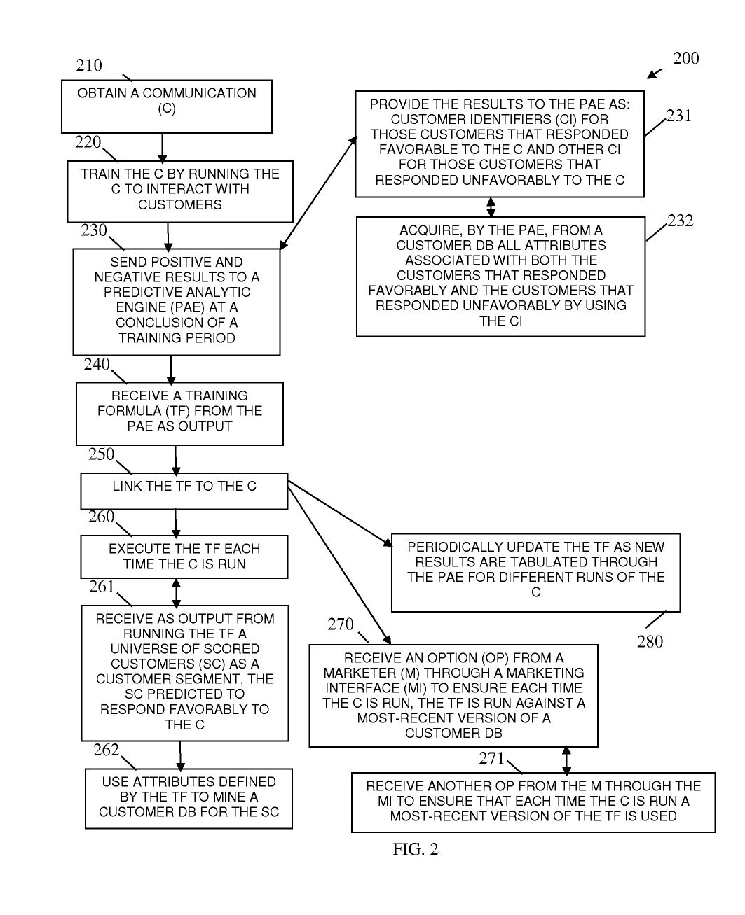

The above-discussed embodiments and other embodiments are now discussed with reference to the FIGS. 2-4.

FIG. 2 is a diagram of a method 200 optimizing customer leads for a communication of a campaign, according to an example embodiment. The method 200 (hereinafter “communication segment universe manager”) is implemented as executable instructions (as one or more software modules) within memory and/or non-transitory computer-readable storage medium that execute on one or more processors, the processors specifically configured to execute the communication segment universe manager. Moreover, the communication segment universe manager is programmed within memory and/or a non-transitory computer-readable storage medium. The attribute snapshot manager may have access to one or more networks, which can be wired, wireless, or a combination of wired and wireless.

In an embodiment, the communication segment universe manager implements, inter alia, the techniques discussed above with reference to the FIG. 1.

At 210, the communication segment universe manager obtains a communication associated with a marketing campaign.

At 220, the communication segment universe manager trains the communication by running the communication to interact with customers and obtain feedback as favorable or unfavorable results.

At 230, the communication segment universe manager sends positive and negative results to a predictive analytic engine at a conclusion of a training period. In an embodiment, the training period is marketer defined. The marketer, at least partially, interacting with the communication segment universe manager through a marketing interface.

According to an embodiment, at 231, the communication segment universe manager provides the results to the predictive analytic engine as: customer identifiers for those customer that responded favorably to the communication and other customer identifiers for those customers that responded unfavorable (perhaps not at all) to the communication.

In an embodiment of 231 and at 232, the communication segment universe manager acquires from a customer database all attributes associated with both the customers that responded favorably and the customers that responded unfavorably by using the customer identifiers as a search or index in the customer database.

At 240, the communication segment universe manager receives a training formula from the predictive analytic engine as output.

At 250, the communication segment universe manager links or associated the training formula to the communication.

In an embodiment, at 260, the communication segment universe manager executes the training formula each time the communication is run.

In an embodiment of 260 and at 261, the communication segment universe manager receives as output from running the training formula a universe of scored customers as a customer segment. The scored customers predicted to respond favorably by the predictive analytic engine based on the training period.

In an embodiment of 261 and at 262, the communication segment universe manager uses attributes defined by the training formula to mine a customer database for the scored customers.

In an embodiment, at 270, the communication segment universe manager receives an option from a marketer through a marketing interface to ensure each time the communication is run the training formula is run against a most-recent version of a customer database.

In an embodiment of 270 and at 271, the communication segment universe manager receives another option from the marketer through the marketing interface to ensure that each time the communication is run a most-recent version of the training formula is used.

In an embodiment, at 280, the communication segment universe manager periodically updates the training formula as new results are tabulated through the predictive analytic engine for different runs of the communication.

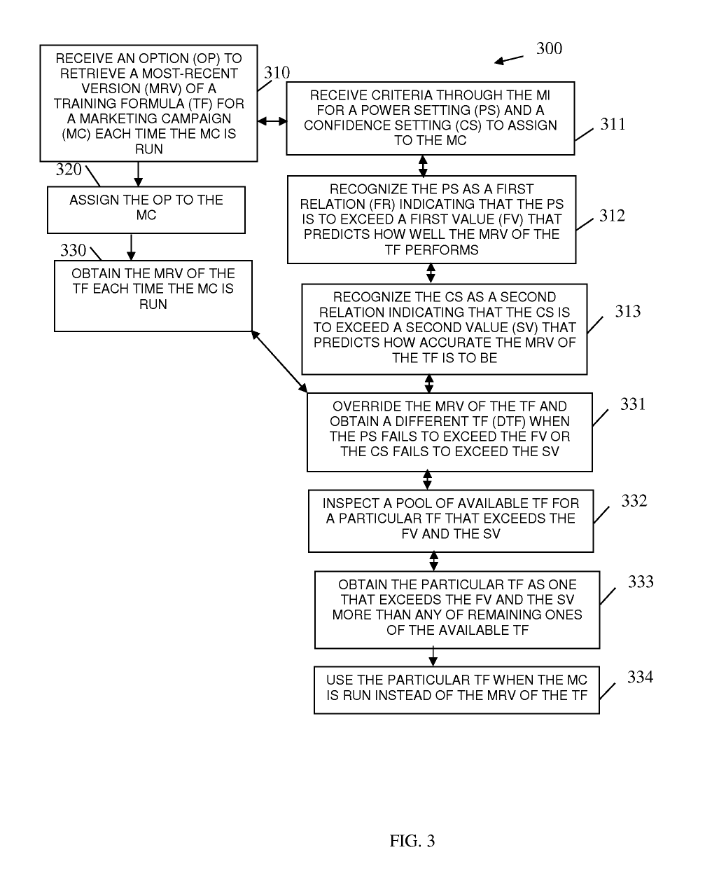

FIG. 3 is a diagram of a method 300 for automated up-to-date predictive analytics for a marketing campaign, according to an example embodiment. The method 300 (hereinafter “automated predictive module selection manager”) is implemented as executable instructions as one or more software modules within memory and/or a non-transitory computer-readable storage medium that execute on one or more processors, the processors specifically configured to execute the automated predictive module selection manager. Moreover, the automated predictive module selection manager is programmed within memory and/or a non-transitory computer-readable storage medium. The automated predictive module selection manager has access to one or more network, which can be wired, wireless, or a combination of wired and wireless.

In an embodiment, the automated predictive module selection manager implements, inter alia, the techniques discussed above with reference to the FIG. 1.

At 310, the automated predictive module selection manager receives an option to retrieve a most-recent version of a training formula for a marketing campaign each time the marketing campaign is run.

In an embodiment, at 311, the automated predictive module selection manager receives criteria through the marketing interface for a power setting and a confidence setting to assign to the marketing campaign.

In an embodiment of 311 and at 312, the automated predictive module selection manager recognizes the power setting as a first relation indicating that the power setting is to exceed a first value that predicts how well the most-recent version of the training formula performs.

In an embodiment of 312 and at 313, the automated predictive module selection manager recognizes the confidence setting as a second relation indicating that the confidence setting is to exceed a second value that predicts how accurate the most-recent version of the training formula is to be.

At 320, the automated predictive module selection manager assigns or links the option to the marketing campaign.

At 330, the automated predictive module selection manager obtains the most-recent version of the training formula each time the marketing campaign is run.

In an embodiment of 313 and 330, at 331, the automated predictive module selection manager overrides the most-recent version of the training formula when the power setting fails to exceed the first value or when the confidence setting fails to exceed the second value.

In an embodiment of 331 and at 332, the automated predictive module selection manager inspects a pool of available training formulas for a particular training formula that exceeds both the first value and the second value.

In an embodiment of 332 and at 333, the automated predictive module selection manager obtains the particular training formula as on that exceeds both the first value and the second value more than any remaining ones of the available training formulas.

In an embodiment of 333 and at 334, the automated predictive module selection manager uses the particular training formula when the marketing campaign is run instead of the most-recent version of the training formula.

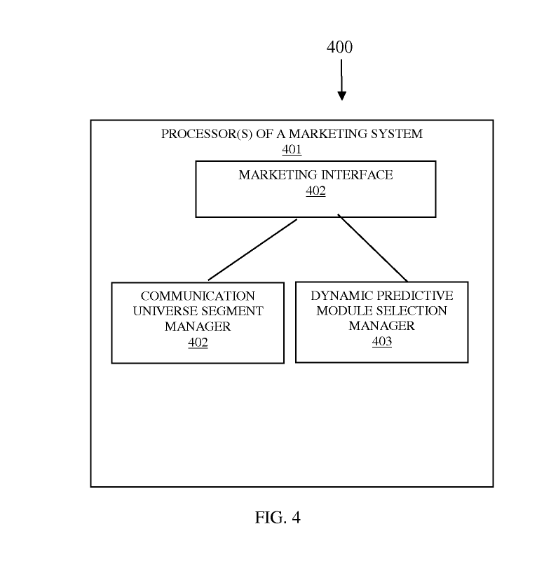

FIG. 4 is a diagram of an automated and dynamic predictive analytic system 400, according to an example embodiment, according to an example embodiment. The automated and dynamic predictive analytic system 400 includes hardware components, such as memory and one or more processors. Moreover, the automated and dynamic predictive analytic system 400 includes software resources, which are implemented, reside, and are programmed within memory and/or a non-transitory computer-readable storage medium and execute on the one or more processors, specifically configured to execute the software resources. Moreover, the automated and dynamic predictive analytic system 400 has access to one or more networks, which are wired, wireless, or a combination of wired and wireless.

In an embodiment, the automated and dynamic predictive analytic system 400 implements, inter alia, the techniques of the FIG. 1.

In an embodiment, the automated and dynamic predictive analytic system 400 implements, inter alia, the techniques of the FIG. 2.

In an embodiment, the automated and dynamic predictive analytic system 400 implements, inter alia, the techniques of the FIG. 3.

In an embodiment, the automated and dynamic predictive analytic system 400 implements, inter alia, the techniques of the FIG. 1 and the FIG. 2.

The automated and dynamic predictive analytic system 400 includes processor(s) 401 of a marketing system, a marketing interface 402, a communication universe segment manager 403 and a dynamic predictive module selection manager 403.

The communication universe segment manager 403 is configured to: execute on the processor(s) 401 and obtain a training formula from a predictive analytic engine at a conclusion of a training period for a communication and linking that training formula to the communication each time the communication is run to obtain a segment of customers to pursue in a marketing campaign.

The dynamic predictive module selection manager 403 is configured to: execute on the processor(s) 401, assign an option to the marketing campaign, and use the option to obtain a most-recent version of a training formula for the marketing campaign each time the marketing campaign is run to acquire scored leads to pursue in the marketing campaign.

In an embodiment, the training period is set by a marketer through a marketing interface in communication with the communication universe segment manager 402.

According to an embodiment, the option is set by a marketer through a marketing interface in communication with the dynamic predictive module selection manager 403.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
obtaining, by a processor, a communication;
training, by the processor, the communication by running the communication to interact with customers;
sending, by the processor, positive and negative results to a predictive analytic engine at a conclusion of a training period;
receiving, by the processor, a training formula from the predictive analytic engine as output; and
linking, by the processor, the training formula to the communication.

2. The method of claim 1 further comprising, executing, the training formula, each time the communication is run.

3. The method of claim 2, wherein executing further includes receiving as output from running the training formula a universe of scored customers as a customer segment, the scored customers predicted to respond favorably to the communication.

4. The method of claim 3, wherein executing further includes using attributes defined by the training formula to mine a customer database for the scored customers.

5. The method of claim 1 further comprising, receiving an option from a marketer through a marketing interface to ensure that each time the communication is run, the training formula is run against a most recent version of a customer database.

6. The method of claim 5, wherein receiving further includes receiving another option from the marketer through the marketing interface to ensure that each time the communication is run a most-recent version of the training formula is used.

7. The method of claim 1 further comprising, periodically updating, by the processor, the training formula as new results are tabulated through the predictive analytic engine for different runs of the communication.

8. The method of claim 1, wherein sending further includes providing the results to the predictive analytic engine as: customer identifiers for those customers that responded favorably to the communication and other customer identifiers for those customers that responded unfavorably to the communication.

9. The method of claim 8, wherein providing further includes, acquiring, by the predictive analytic engine, from a customer database all attributes associated with both the customers that responded favorably and the customers that responded unfavorably by using the customer identifiers.

10. A method, comprising:
receiving, by a processor, an option to retrieve a most-recent version of a training formula for a marketing campaign each time the marketing campaign is run;
assigning, by the processor, the option to the marketing campaign; and
obtaining, by the processor, the most-recent version of the training formula each time the marketing campaign is run.

11. The method of claim 10, wherein receiving further includes receiving criteria through the marketing interface for a power setting and a confidence setting to assign to the marketing campaign.

12. The method of claim 11, wherein receiving further includes recognizing the power setting as a first relation indicating that the power setting is to exceed a first value that predicts how well the most-recent version of the training formula performs.

13. The method of claim 12, wherein recognizing further includes recognizing the confidence setting as a second relation indicating that the confidence setting is to exceed a second value that predicts how accurate the most-recent version of the training formula is to be.

14. The method of claim 13, wherein obtaining further includes overriding the most-recent version of the training formula and obtaining a different training formula when the power setting fails to exceed the first value or the confidence setting fails to exceed the second value.

15. The method of claim 14, wherein overriding further includes inspecting a pool of available training formulas for a particular training formula that exceeds the first value and the second value.

16. The method of claim 15, wherein inspecting further includes obtaining the particular training formula as one that exceeds the first value and the second value more than any of remaining ones of the available training formulas.

17. The method of claim 16 further comprising, using the particular training formula when the marketing campaign is run instead of the most-recent version of the training formula.

18. A system, comprising:
a processor of a marketing system;
a communication universe segment manager configured to: i) execute on the processor and ii) obtain a training formula from a predictive analytic engine at a conclusion of a training period for a communication and linking that training formula to the communication each time the communication is run to obtain a segment of customers to pursue in a marketing campaign; and
dynamic predictive module selection manager configured to: i) execute on the processor, ii) assign an option to the marketing campaign, and iii) use the option to obtain a most-recent version of a training formula for the marketing campaign each time the marketing campaign is run to acquire scored leads to pursue in the marketing campaign.

19. The system of claim 18, wherein the training period is set by a marketer through a marketing interface in communication with the communication universe segment manager.

20. The system of claim 18, wherein the option is set by a marketer through a marketing interface in communication with the dynamic predictive module selection manager.
